(19) United States
(12) Patent Application Publication
(10) Pub. No.: US 2014/0084505 A1
(43) Pub. Date: Mar. 27, 2014

(54) BLENDED ALUMINAS TO CONTROL ALUMINUM TITANATE PROPERTIES

(71) Applicants: Elizabeth Marie Vileno, Corning, NY (US); Christopher John Warren, Waverly, NY (US)

(72) Inventors: Elizabeth Marie Vileno, Corning, NY (US); Christopher John Warren, Waverly, NY (US)

(21) Appl. No.: 13/624,043

(22) Filed: Sep. 21, 2012

(51) Int. Cl. C04B 35/64

(52) U.S. Cl. 264/43; 264/681

(57) ABSTRACT

A method of making an aluminum titanate ceramic article including:
selecting properties for the aluminum titanate-containing ceramic body to be made by the method, the selected properties include pore size, modulus of rupture (MOR), or both;
selecting a fine-to-coarse weight ratio (f:c) of fine alumina particles and coarse alumina particles for a batch, the total amount of the fine and the coarse alumina particles is from 44 to 52 weight percent of the batch;
forming an aluminum titanate batch mixture including the selected fine-to-coarse weight ratio (f:c) of the fine alumina particles and the coarse alumina particles;
forming a green body from the batch mixture; and
firing the green body to obtain an aluminum titanate-containing ceramic body having the selected properties, as defined herein.

The entire disclosure of any publication or patent document mentioned herein is incorporated by reference.

### BACKGROUND

The disclosure generally relates to a method of making aluminum titanate ceramic articles.

### SUMMARY

In embodiments, the present disclosure provides a method of making aluminum titanate ceramic articles that uses the ratios of two different aluminas, specifically a fine particle size alumina (“Alumina 2”) and a coarse particle size alumina (“Alumina 1”), to control the physical and ceramic filter performance properties. In embodiments, compositions having a predominantly coarse particle size alumina can give ceramic products having a larger overall pore size, which can enable higher catalyst loading. Compositions having a predominantly fine particle size alumina can give ceramic products having higher strength.

### BRIEF DESCRIPTION OF DRAWINGS

In embodiments:

FIG. 1 graphically shows comparative particle size distributions for fine (diamonds) and coarse (squares) aluminas.

FIG. 2 graphically shows porosity properties of filter bodies as a weight percentage of fine particle size alumina content.

FIG. 3 graphically shows coefficient of thermal expansion (CTE) properties of filter bodies as a weight percentage of fine particle size alumina content.

FIG. 4 graphically shows shrinkage properties of filter bodies as a weight percentage of fine particle size alumina content for the “mask-to-fired” article.

FIG. 5 graphically shows the distribution of pore size properties of filter bodies as the weight percentage of fine particle size alumina content increases.

FIG. 6 graphically shows modulus of rupture (MOR) properties of filter bodies as a weight percentage of fine particle size alumina content.

FIG. 7 shows the particle size distribution of the various batch ingredients used in making selected filter body compositions.

FIG. 8 shows the particle size distribution of the listed ingredients used in making selected filter body compositions.

### DETAILED DESCRIPTION

The foregoing general description and the following detailed description are exemplary and explanatory only and are not restrictive of the claimed invention. Other embodiments will be apparent to those skilled in the art from consideration of the specification and practice of the embodiments disclosed herein. It is intended that the specification and examples be considered as exemplary only, with the true scope of the invention being indicated by the claims.

### DEFINITIONS

The indefinite article “a” or “an” and its corresponding definite article “the” as used herein means at least one, or one or more, unless specified otherwise.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

Unless indicated otherwise, all numbers used in the specification and claims are to be understood as being modified in all instances by the term “about,” whether or not so stated. The precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

“Consisting essentially of” in embodiments refers, for example, to a formulation or composition, and articles, devices, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agent, a particular surface modifier or condition, or like structure, material, or process variable selected.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “bp” for boiling point, and like abbreviations).

Specific and preferred values disclosed for components, ingredients, additives, and like aspects, and ranges thereof, are for illustration only; they do not exclude other defined values or other values within defined ranges. The formulations, compositions, devices, apparatus, and methods of the disclosure can include any value or any combination of the values, specific values, more specific values, and preferred values described herein.

Alumina can comprise up to about 50 wt % of an aluminum titanate (AT) batch. Given this large percentage of alumina in the composition, any change in the consistency of the alumina material can dramatically affect properties of the final product. Accordingly, considerable care has been taken to maintain material consistency. While this has resulted in a reasonably robust product in terms of final fired properties and shrinkage behavior, having only a single specified size of alumina does not allow an easy change of properties and requires other approaches to adjust for or react to shrinkage upsets. In approaches to the future generation, low and high porosity aluminum titanate compositions, other ingredients (e.g., one or more pore formers, a carbonate, methylcellulose, and like ingredients) were examined as a way to achieve the desired final properties. With low porosity aluminum titanate, a silica, a blended 2:1=K:F METHOCEL™ cellulose ether (i.e., premium grade hydroxypropyl methylcellulose having different % methoxy and % hydroxypropoxy substitution levels) ratio, and a mix of graphite and pea starch as the pore formers, were all used to adjust the properties and maintain shrinkage control.

Commonly owned and assigned related copending patent applications disclose selecting a narrow particle size distribution alumina (U.S. Ser. No. 12/550,011), or matching the alumina particle size to the pore former size (U.S. Ser. No. 12/394,956). Commonly owned U.S. Ser. No. 12/844,250 mentions the use of a higher sodium content in a fine particle size alumina (“Alumina 2”) and the advantages alkali metals can afford as a shrinkage control strategy. Commonly owned U.S. Ser. No. 12/624,998 mentions how to make a fine particle size alumina (“Alumina 2”) work in a DuraTrap® AT ceramic filter product by using coarser “other” organic and inorganic ingredients to counter the effect that a finer particle size alumina component can impart to the final properties of the fired ceramic.

In general, having an ability to control aluminum titanate ceramic filter properties by adjusting the ratio of just two ingredients is a highly desirable manufacturing strategy. The present disclosure provides a detailed description that achieves this strategy.

The disclosure relates to methods for making aluminum titanate-containing ceramic materials. “Batch material” and variations thereof, refer to a substantially homogeneous mixture comprising: a) inorganic materials; b) a pore-forming material; and c) a binder.

In various exemplary embodiments, the inorganic materials may comprise particles from at least one alumina source, for example, having a single particle size distribution for a single alumina source or two different particle size distributions for two different alumina sources, at least one titania source, at least one silica source, at least one strontium source, and at least one calcium source.

Sources of alumina can include powders that when heated to a sufficiently high temperature in the absence of other raw materials, will yield substantially pure aluminum oxide.

In embodiments, the total alumina source can comprise at least 44 wt %, but not more than 52 wt % of the inorganic materials, such as, for example, 47.0 to 51.9 wt % of the inorganic materials, including intermediate values and ranges.

In embodiments, the total alumina source can be a single fine particle size alumina (“Alumina 2”), a single coarse particle size alumina (“Alumina 1”), or a combination thereof. The Alumina 1 coarse particle size alumina can have, for example, a d50 of 10 to 12 microns, and the Alumina 2 fine particle size alumina can have, for example, a d50 of 6 to 9 microns.

The total alumina source can be selected so that the median particle diameter of the alumina source is, for example, from 1 to 45 microns, from 2 to 25 microns, from 5 to 20 microns, from 8 to 15 microns, from 9 to 12 microns, including intermediate values and ranges, such as, for example, from 9.0 to 11.0 microns.

In embodiments, the disclosure provides compositions and methods including at least one source of alumina, for example, a fine particle alumina (“Alumina 2”), a coarse particle alumina (“Alumina 1”), or combinations thereof. A commercially available fine particle alumina (“Alumina 2”) is A2-325, and a commercially available coarse particle alumina is (“Alumina 1”) A10-325, both available from Almatis, Inc., of Leetsdale, Pa., and those sold under the trade names Microgrit WCA20, WCA25, WCA30, WCA40, WCA45, and WCA50 available from Micro Abrasives Corp., of Westfield, Mass. In embodiments, the at least one alumina source is the aforementioned fine particle alumina A2-325 (“Alumina 2”).

Sources of titania can include, but are not limited to, rutile, anatase, and amorphous titania. For example, in embodiments, the at least one titania source can be Ti-Pure® R-101 available from DuPont Titanium Technologies of Wilmington, Del.

In embodiments, the at least one titania source can comprise at least 20 wt % of the inorganic materials, for example at least 25 wt % or at least 30 wt % of the inorganic materials.

Sources of silica can include non-crystalline silica, such as fused silica or sol-gel silica, silicone resin, low-alumina substantially alkali-free zeolite, diatomaceous silica, kaolin, and crystalline silica, such as quartz or cristobalite. Additionally, the sources of silica can include silica-forming sources that comprise a compound that forms free silica when heated, for example, silicic acid or a silicon organometallic compound. For example, in embodiments, the at least one silica source can be Cerasil 300 available from Unimin of Troy Grove, Ill., or Imsil A25 available from Unimin of Elco, Ill.

In embodiments, the at least one silica source can comprise at least 5 wt % of the inorganic materials, for example at least 8 wt % or at least 10 wt % of the inorganic materials.

Sources of strontium can include strontium carbonate and strontium nitrate. For example, in embodiments, the at least one strontium source can be strontium carbonate of Type W or Type DF, available from Solvay & CPC Barium Strontium of Hannover, Germany.

In embodiments, the at least one strontium source can comprise at least 5 wt % of the inorganic materials, for example, at least 8 wt % of the inorganic materials. In embodiments, one can select the at least one strontium source so that the median particle diameter of the at least one strontium source can be, for example, from 1 to 30 microns, or from 3 to 25 microns, for example, from 11 to 15 microns.

Sources of calcium can include ground (GCC) and precipitated (PCC) calcium carbonate. For example, in embodiments, the at least one calcium source can be calcium carbonate Hydrocarb OG available from OMYA North America Inc., of Cincinnati, Ohio or types W4 or M4 by J.M. Huber Corporation of Edison, N.J.

In embodiments, the at least one calcium source can comprise at least 0.5 wt % of the inorganic materials, for example at least 1 wt % of the inorganic materials. In embodiments, one can select the at least one calcium source so that the median particle diameter of the at least one calcium source is from 1 to 30 microns, for example from 4.5 to 10 microns.

In embodiments, the inorganic materials can further comprise at least one lanthanum source. Sources of lanthanum can include, for example, lanthanum oxide, lanthanum carbonate, and lanthanum oxalate. In embodiments, the at least one lanthanum source can be, for example, lanthanum oxide type 5205 available from MolyCorp Minerals, LLC, of Mountain Pass, Calif.

In embodiments, the at least one lanthanum source can comprise at least 0.05 wt % of the inorganic materials, for example, at least 0.1 wt % or 0.2 wt % of the inorganic materials. In embodiments, one can select the at least one lanthanum source so that the median particle diameter of the at least one lanthanum source is from 1 to 40 microns, for example, from 11 to 15 microns.

In embodiments, the pore-forming material can include, for example, a single pore former such as a graphite, a starch, or a wheat pore former, or a mix of any two or more pore formers.

Sources of graphite pore former can include, for example, natural graphite, synthetic graphite, or combinations thereof. In embodiments, the at least one graphite can be, for example, type A625, 4602, 4623, or 4740 available from Asbury Graphite Mills of Asbury, N.J.

In embodiments, one can select the at least one graphite so that the median particle diameter can be from 1 to 400 microns, or 5 to 300 microns, such as for example from 40 to 110 microns, including intermediate values and ranges.

Sources of starch can include, for example, corn, barley, bean, potato, rice, tapioca, pea, sago palm, wheat, canna, and walnut shell flour. In embodiments, the at least one starch can be selected from rice, corn, wheat, sago palm, and potato. For example, in embodiments, the at least one starch can be potato starch, for example, native potato starch available from Emsland-Starke GmbH of Emlichheim, Germany.

In embodiments, one can select the at least one starch so that the median particle diameter of the at least one starch can be from 1 to 100 microns, or 25 to 75 microns, for example from 40 to 50 microns, including intermediate values and ranges.

In embodiments, the pore-forming material can be present in any amount to achieve a desired result. For example, the pore-forming material can comprise at least 1 wt % of the batch material, added as a super-addition (i.e., the inorganic materials comprise 100% of the batch material, such that the total batch material is 101%). For example, the pore-forming material can comprise at least 5 wt %, at least 10 wt %, at least 15 wt %, at least 18 wt %, at least 20 wt %, at least 30 wt %, at least 40 wt %, at least 50 wt %, of the batch material added as a super-addition. In embodiments, the pore-forming material can comprise, for example, less than 20 wt % of the batch material as a super-addition, such as for example 18 wt %. In embodiments, the graphite pore former can comprise at least 1 wt % of the batch material as a super-addition, for example, at least 5 wt %, such as 10 wt %. In embodiments, the starch pore former, such as potato starch, wheat flour, or wheat starch, can comprise, for example, at least 1 wt % of the batch material as a super-addition, for example, at least 5 wt %, such as 8 wt %.

In embodiments, the inorganic materials can be selected from, for example: particles of a strontium source having a median particle diameter of from 11 to 15 microns; particles of an aluminum source comprising fine particle size alumina having a median particle diameter of from 6 to 10, and from 6 to 9 microns, coarse particle size alumina having a median particle diameter of 10 to 13 microns, and from 10 to 12 microns, or a mixture thereof; particles of a silica source can have a median particle diameter of about 20 to 30 microns, such as 26 microns; and particles of at least one calcium source having a median particle diameter of from 4.5 to 10 microns.

In embodiments, at least two or at least three of the inorganic materials can be chosen from the group for a given batch material. In embodiments, a batch material can comprise particles of at least one strontium source having a median particle diameter of from 11 to 15 microns; particles of at least one fine particle alumina source having a median particle diameter of from 9 to 10 microns; and particles of at least one calcium source having a median particle diameter of from 4.5 to 10 microns. The particles of at least one graphite pore former can have a median particle diameter of from 40 to 110 microns.

In embodiments, the disclosure provides a method for making aluminum titanate-containing ceramic bodies using the batch materials of the disclosure, the method can comprise, for example:

selecting target properties for the aluminum titanate-containing ceramic body, including pore size, MOR, or both;

preparing the batch material;

forming a green body from the batch material; and

firing the green body to obtain an aluminum titanate-containing ceramic body having the selected target properties.

In embodiments, the disclosure provides a method of making an aluminum titanate ceramic article comprising:

selecting properties, i.e., target properties, for the aluminum titanate-containing ceramic body to be made by the method, the selected properties include, for example, pore size, modulus of rupture (MOR), or a combination thereof;

selecting a fine-to-coarse weight ratio (f:c) of fine alumina particles and coarse alumina particles for a batch, the total amount of the fine and the coarse alumina particles is from 44 to 52 weight percent of the batch;

forming an aluminum titanate batch mixture including the selected fine-to-coarse weight ratio (f:c) of the fine alumina particles and the coarse alumina particles;

forming a green body from the batch mixture; and

firing the green body to obtain an aluminum titanate-containing ceramic body having the selected properties.

In embodiments, the selected fine-to-coarse weight ratio (f:c) of the fine and the coarse alumina particles can be, for example, fixed for a particular batch.

In embodiments, the method can further comprise, in a subsequent method of making:

varying the fine-to-coarse weight ratio (f:c) of the fine alumina particles and the coarse alumina particles for the batch; and

holding the amount of all other batch ingredients constant, wherein the selected properties in the resulting fired green body are adjusted or shifted to a different value compared to the prior method of making.

The fine-to-coarse weight ratio (f:c) of the fine and the coarse alumina particles can be, for example, from 0:100 to 100:0, including intermediate values and ranges.

The total amount of all alumina particles can be, for example, 47 to 50 weight percent of the batch, including intermediate values and ranges.

The fine alumina particles can be, for example, a first alumina having a median particle size of 6 to 10 micrometers, preferably a median particle size of 6.5 to 9 micrometers, more preferably a median particle size of 7 to 9 micrometers, even more preferably a median particle size of 7.5 to 9 micrometers and still more preferably a median particle size of 8 to 9 micrometers, including intermediate values and ranges, and the coarse alumina particles comprise a second alumina having a median particle size of 10 to 13 micrometers, preferably a median particle size of 10.2 to 12 micrometers, more preferably a median particle size of 10.5 to 11.5 micrometers, even more preferably a median particle size of 10.75 to 11.5 micrometers, and still more preferably 11 to 11.5 micrometers, including intermediate values and ranges. The fine particle size alumina can be, for example, an A2-325 alumina (“Alumina 2”) having a median particle size of 9.88 microns, and the coarse particle size alumina can be, for example, an A10-325 alumina having median particle size of 12.17 microns.

In embodiments, the batch can include, for example, one or more pore formers in an amount from 5 to 30 weight percent based on superaddition to the inorganic components of the batch. Combining the mixed aluminas with a pore former can provide additional control over specific pore size properties.

In embodiments, the batch can include, for example, one or more pore formers selected from starch, graphite, wheat, and like materials, or a mixture thereof.

The firing the green body can comprise, for example, heating in a gas fired kiln for 16 hr, and cooling to ambient temperature, and like effective firing processes.

The firing can provide an aluminum titanate ceramic article having a pore size, for example, from 11 to 14 microns, including intermediate values and ranges, and, for example, a modulus of rupture (MOR), from 130 to 290, including intermediate values and ranges. The selected modulus of rupture (MOR) property can be, for example, from 140 to 280 MPa, and from 150 to 223 MPa, including intermediate values and ranges.

The selected pore size property can be, for example, a d50 from 10 to 20 microns, and from 11 to 14 microns, including intermediate values and ranges. The method provides an aluminum titanate ceramic article having the selected pore size properties and without a change in porosity properties, i.e., porosity remains constant.

The batch material can be made and combined by any method known in the art. In embodiments, the inorganic materials can be combined as powdered materials and intimately mixed to form a substantially homogeneous mixture. The pore-forming material can be added to form a batch mixture before or after the inorganic materials are intimately mixed. In embodiments, the pore-forming material and inorganic materials can then be intimately mixed to form a substantially homogeneous batch material.

In embodiments, batch material can be mixed with any other known component useful for making batch material. For example, a binder, such as an organic binder, or a solvent can be added to the batch material to form a plasticized mixture. One skilled in the art can select an appropriate binder. By way of example, an organic binder can be chosen from cellulose-containing components. For example, methylcellulose, such as hydroxypropyl methylcellulose, methylcellulose derivatives, and combinations thereof, can be used. In embodiments, the solvent can be water, for example deionized water.

The additional components, such as organic binder and solvent, can be mixed with the batch material individually, in any order, or together to form a substantially homogeneous mixture. One of skill in the art can determine the appropriate conditions for mixing the batch material with the additional components, such as organic binder and solvent, to achieve a substantially homogeneous material. For example, the components can be mixed by a kneading process to form a substantially homogeneous mixture.

The mixture may, in various embodiments, be shaped into a ceramic body by any known process. By way of example, the mixture can be injection molded or extruded, and optionally dried by conventional methods known to those skilled in the art to form a green body. In embodiments, the green body can then be fired to form an aluminum titanate-containing ceramic body.

One skilled in the art can determine the appropriate method and conditions for forming a ceramic body, depending in part upon the size and composition of the green body, for example, firing conditions including equipment, temperature, and duration, to achieve an aluminum titanate-containing ceramic body. Non-limiting examples of firing cycles for aluminum titanate-containing ceramic bodies can be found, for example, in International Publication No. WO 2006/130759, which is incorporated herein by reference.

By careful selection of the combinations of the batch materials, one can tailor the properties of aluminum titanate-containing ceramic bodies of the disclosure, for example, to have a particular median pore diameter, MOR, CTE, or a combination thereof. In embodiments, this can be achieved by selecting batch materials for the disclosed aluminum titanate-containing ceramic bodies based, in part, upon the median particle size or coarseness of the materials. In embodiments, the aluminum titanate-containing ceramic bodies obtained from the disclosed batch materials, can have the at least one alumina source having a median particle diameter of from 9 to 10 microns, the pore-forming material can comprise less than 20 wt % of the batch material as a super-addition, and the at least one of the inorganic materials can be selected from: particles of at least one strontium source having a median particle diameter from 11 to 15 microns; particles of at least one fine particle size alumina source having a median particle diameter from 9 to 10 microns; and particles of at least one calcium source having a median particle diameter of from 4.5 to 10 microns. The at least one pore-forming material can be particles of at least one graphite having a median particle diameter of from 40 to 110 microns, and the fired body can have a median pore diameter of from 13 to 15 microns, a MOR greater than 220 psi, a CTE @ 800° C. of less than 6, a porosity of from 48 to 52 vol %, and combinations thereof.

As used herein, the term “comparative aluminum titanate-containing ceramic body” means an aluminum titanate-containing ceramic body made from comparative batch material that is shaped and fired in substantially the same manner as the aluminum titanate-containing ceramic body of the disclosure. “Comparative batch materials” comprise the same components as the disclosed batch materials and vary at least in that the at least one alumina source of the comparative batch material is coarser than that of the batch material. As used herein, the term “coarser,” and variations thereof, means that the median particle diameter of a given source of material is greater than another source of the same material. For example, an alumina source having a median particle diameter of 12 microns is coarser than an alumina source having a median particle diameter of 10 microns. Conversely, it can be said that the alumina source of the batch material of the disclosure is “finer” than that of the comparative batch material if the finer median particle diameter is smaller than that of the comparative batch.

In embodiments of the disclosure, comparative batch material can comprise inorganic materials comprising particles from at least one alumina source, at least one titania source, at least one silica source, at least one strontium source, and at least one calcium source, and pore-forming materials comprising particles from at least one graphite, and optionally at least one starch. However, the at least one alumina source of the comparative batch material is coarser than that of the inventive batch materials of the disclosure.

In embodiments, the comparative batch material can have the same stoichiometry as that of the inventive batch material but can have different particle size distributions compared to the inventive batch material.

In embodiments, the components of the inventive batch material can be select so that aluminum titanate-containing ceramic bodies made therefrom can have median pore sizes of from 5 to 35 microns, such as, for example, of from 13 to 17 microns, or from 13 to 15 microns, including intermediate values and ranges.

In embodiments, the components of the batch material can be selected so that aluminum titanate-containing ceramic bodies made therefrom have porosities ranging from 30% to 65%, for example ranging from 35% to 60%, from 40% to 58%, or from 48% to 56%, including intermediate values and ranges.

In embodiments, the aluminum titanate-containing ceramic bodies can have a MOR on cellular ware (e.g., 300 cells per square inch (cpsi)/13 mil web thickness) of 200 psi or greater, such as, for example, greater than 220 psi, such as 250 psi or greater or 300 psi or greater.

In embodiments, the aluminum titanate-containing ceramic bodies can have a CTE at 800° C. of less than 6, for example of less than 5, or less than 4.

In embodiments, the aluminum titanate-containing ceramic bodies can have a median pore size of from 13 to 15 microns, a porosity ranging from 48% to 56%, a MOR of greater than 220 psi, and a CTE at 800° C. of less than 6.

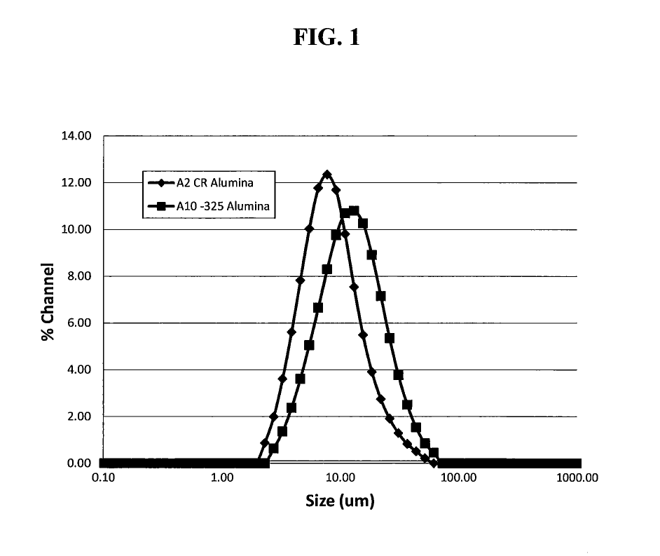

Referring to the figures, FIG. 1 graphically shows comparative particle size distributions for an exemplary fine alumina (“Alumina 2”) (diamonds) and an exemplary coarse alumina (“Alumina 1”)(squares).

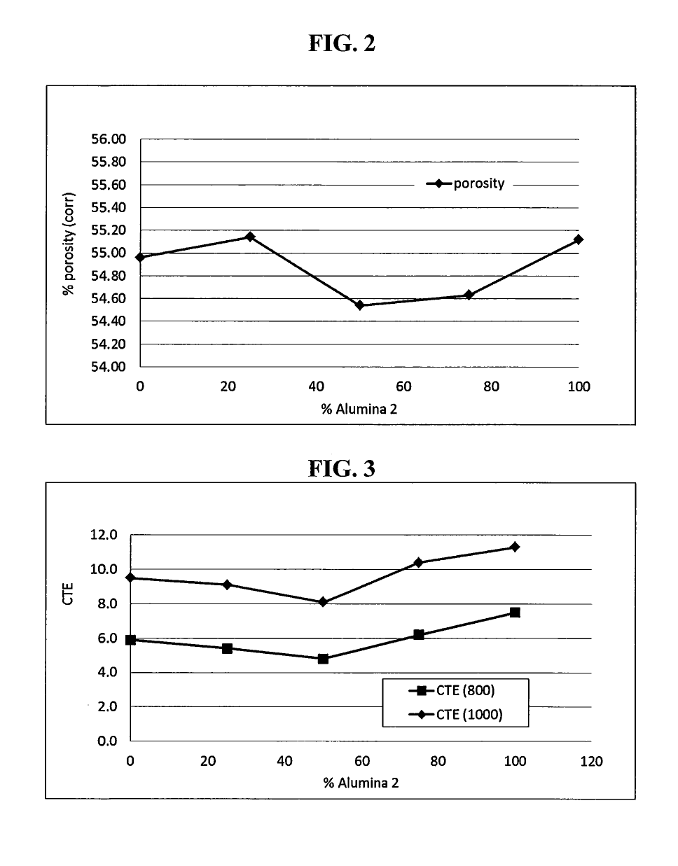

FIG. 2 graphically shows porosity properties of prepared filter bodies as a weight percentage of fine particle size alumina (“Alumina 2”) content. The balance, if any, is coarse particle size alumina (“Alumina 1”) in wt %.

FIG. 3 graphically shows coefficient of thermal expansion (CTE) properties of prepared filter bodies as a weight percentage of fine particle size alumina content. The balance, if any, is coarse particle size alumina (“Alumina 1”) in wt %. The coefficient of thermal expansion, CTE, is measured by dilatometry along the axial direction of the specimen, which is the direction parallel to the lengths of the honeycomb channels. The value of CTE_{25-800° C.} (CTE (800)) is the mean coefficient of thermal expansion from about 25° C. to about 800° C.×10⁻⁷/° C., and the value of CTE_{25-1000° C.} (CTE (1000)) is the mean coefficient of thermal expansion from about 25° C. to about 1,000° C.×10⁻⁷/° C., all as measured during heating of the sample. A low value of CTE is desired for high thermal durability and thermal shock resistance. A low value of CTE yields higher values for the thermal shock parameter, (MOR_{25° C.}/E_{25° C.})(CTE_{500-900° C.})⁻¹.

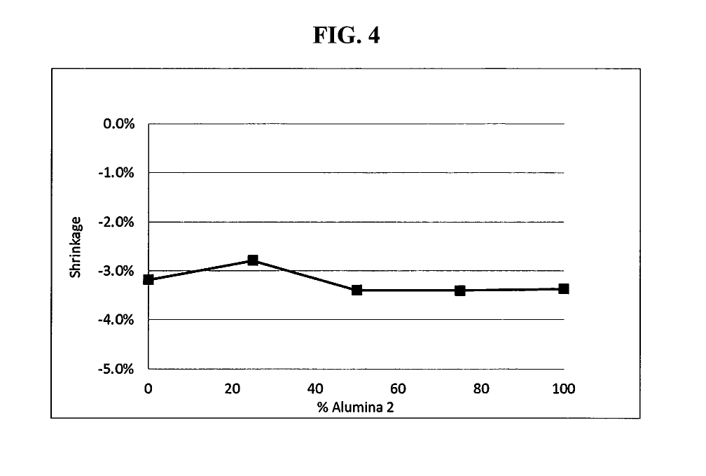

FIG. 4 graphically shows shrinkage properties of filter bodies as a weight percentage of fine particle size alumina content for the “mask-to-fired” article. The “mask-to-fired” shrinkage refers to the shrinkage measured relative to the mask used to form it, for example, the change in the diameter of the honeycomb body measured for a formed body that is transformed to a fired ceramic article. If the diameter increases as a result of firing the shrinkage is deemed negative (i.e., negative shrinkage or growth). If the diameter decreases as a result of firing the shrinkage is deemed positive (i.e., positive shrinkage or shrinking). The experimental results of the present disclosure indicate that the shrinkage property (i.e., growth) is relatively constant over the entire weight percentage of 0 to 100% fine particle size alumina, and is, for example, about −2 to −4%.

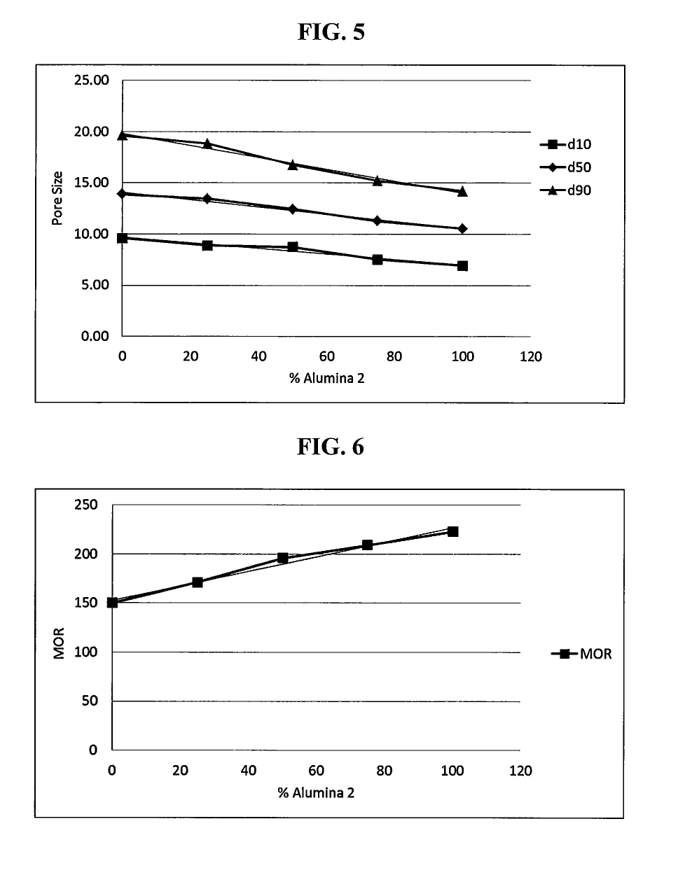

FIG. 5 graphically shows the distribution of pore size properties of filter bodies as the weight percentage of the fine particle size alumina content increases. The equations for the lines (and the R² values) for d10, d50, and d90 are, respectively:

y=−0.0267x+9.672,(0.9579);

y=−0.0354x+14.806,(0.9821); and

y=−0.0577x+19.806,(0.9815).

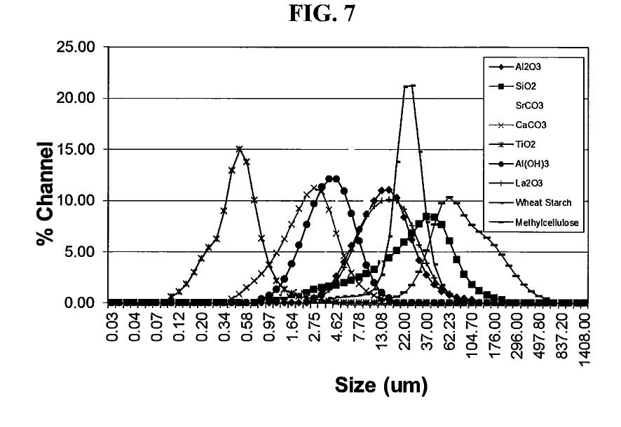

FIG. 6 graphically shows modulus of rupture (MOR) properties of filter bodies as a weight percentage of the fine particle size alumina content. The results indicate that as the weight percentage of fine particle size alumina content increases and the coarse particle size alumina content decreases, the MOR strength of the filter body increases. The equation for the line (and the R² value) for MOR strength is y=0.736x+153, (0.9822).

FIG. 7 shows the particle size distributions of the ingredients used (% channel v. pore size in microns) in the batch materials to form selected filter bodies.

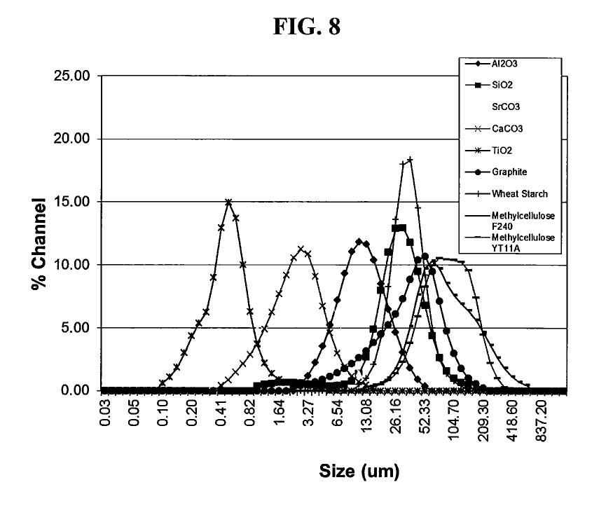

FIG. 8 shows another example of the particle size distributions of the listed ingredients that were used (% channel v. pore size in microns) in batch materials to form selected filter bodies.

### EXAMPLES

The following examples serve to more fully describe the manner of making and using the above-described disclosure, and to further set forth the best modes contemplated for carrying out various aspects of the disclosure. The examples do not limit the scope of this disclosure, but rather are presented for illustrative purposes. The working examples further describe how to prepare and evaluate the articles of the disclosure.

### Example 1

### Preparative Example of Exemplary High Porosity Aluminum Titanate Having a Coarse to Fine Alumina Source Weight Ratio: Alumina 1:Alumina 2=100:0

Table 1 lists exemplary aluminum titanate (AT) batch ingredients having the alumina source in the batch having a coarse to fine alumina source ratio: Alumina 1:Alumina 2=100:0, and the alumina source is present in a total amount of 49.67 wt %.

TABLE 1
Exemplary Aluminum Titanate (AT) Batch Ingredients.

| Ingredient | Ingredient Description | Wt % |
|---|---|---|
| Alumina | Alumina 1 (Almatis A10-325) | 49.67 |
| | Alumina 2 (Almatis A2 -325) | 0 |
| Silica | US Silica Microsil 4515-200 | 10.31 |
| SrCO₃ | Solvay Type DF | 8.10 |
| CaCO₃ | OMYA Hydrocarb OG | 1.39 |
| TiO₂ | Dupont Ti-pure R101 | 30.33 |
| La₂O₃ | MolyCorp 5205 | 0.20 |
| | (added as a super addition to | |
| Pore Formers | the inorganics) | |
| Graphite | Asbury 4566 | 8.00 |
| Starch | Native wheat | 20.00 |
| | (as a super addition to the | |
| | combined inorganics and | |
| Binders | pore formers) | |
| Hydroxypropyl | TY11A | 3.00 |
| methylcellulose | | |
| Hydroxypropyl | Methocel ® F240 | 1.50 |
| methylcellulose | | |

The method of making the aluminum titanate ceramic article can include for example:

selecting target properties for the aluminum titanate-containing ceramic body to be made by the method including pore size, modulus of rupture (MOR), or a combination thereof; and

selecting a fine-to-coarse weight ratio (f:c) of the fine alumina particles and the coarse alumina particles for a batch, the total amount of fine and coarse alumina particles is from 44 to 52 weight percent of the batch.

When the relationships shown in the FIGS. 2 to 6 have been established by experiment, one can select the desired property desired, such as pore size, modulus of rupture (MOR), or a combination thereof, and determine how much to use (i.e., the wt %) by mapping from the relevant property to the wt % Alumina 2 on the x-axis. For example, referring to FIG. 6, if a filter body composition having an MOR=200 is desired, one would formulate with 60 wt % Alumina 2 (i.e., 60% of the 49.67 wt % of the total alumina needed would be Alumina 2). Since the FIGS. 2 to 6 are related, one would obtain a product also having a d10=8, d50=12.5, d90=16 (see FIG. 5); CTE (800)=5; and CTE (1000)=9 (see FIG. 3).

Next, the process can include, for example:

forming an aluminum titanate batch mixture including the selected fine-to-coarse weight ratio (f:c) of the fine alumina particles and the coarse alumina particles, for example, blending all listed ingredients in a mixer;

forming a green body from the batch mixture, for example, by extrusion and microwave drying; and

firing the dried green body to obtain an aluminum titanate-containing ceramic body having the selected properties, for example, by heating for 16 hours with a top soak of 1427° C.

### Example 2

### Preparative Example of Exemplary High Porosity Aluminum Titanate Having a Coarse to Fine Alumina Source Weight Ratio: Alumina 1:Alumina 2=75:25

Table 2 lists the exemplary aluminum titanate (AT) batch ingredients having the alumina source in the batch at a total amount of 49.67 wt %.

TABLE 2
Exemplary Aluminum Titanate (AT) Batch Ingredients.

| Ingredient | Ingredient Description | Wt % in batch |
|---|---|---|
| Alumina (49.67 wt %) | Alumina 1 (Almatis A10-325) | 37.25% |
| | Alumina 2 (Almatis A2 -325) | 12.42% |
| Silica | US Silica Microsil 4515-200 | 10.31 |
| SrCO₃ | Solvay Type DF | 8.10 |
| CaCO₃ | OMYA Hydrocarb OG | 1.39 |
| TiO₂ | Dupont Ti-pure R101 | 30.33 |
| La₂O₃ | MolyCorp 5205 | 0.20 |
| Pore Formers | | |
| Graphite | Asbury 4566 | 8.00 |
| Starch | Native wheat | 20.00 |
| Binders | | |
| Hydroxypropyl | TY11A | 3.00 |
| methylcellulose | | |
| Hydroxypropyl | Methocel ® F240 | 1.50 |
| methylcellulose | | |

Example 1 was repeated with the exception that the batch ingredients were kept the same except the ratio of the Alumina 1:Alumina 2 was changed.

### Example 3

### Preparative Example of Exemplary High Porosity Aluminum Titanate Having a Coarse to Fine Alumina Source Ratio: Alumina 1:Alumina 2=50:50

Table 3 lists exemplary aluminum titanate (AT) batch ingredients having the alumina source in the batch at a total amount of 49.67 wt %.

TABLE 3
Exemplary Aluminum Titanate (AT) Batch Ingredients.

| Ingredient | Ingredient Description | Wt % in batch |
|---|---|---|
| Alumina | Alumina 1 (Almatis A10-325) | 24.84% |
| | Alumina 2 (Almatis A2 -325) | 24.84% |
| Silica | US Silica Microsil 4515-200 | 10.31 |
| SrCO₃ | Solvay Type DF | 8.10 |
| CaCO₃ | OMYA Hydrocarb OG | 1.39 |
| TiO₂ | Dupont Ti-pure R101 | 30.33 |
| La₂O₃ | MolyCorp 5205 | 0.20 |
| Pore Formers | | |
| Graphite | Asbury 4566 | 8.00 |
| Starch | Native wheat | 20.00 |
| Binders | | |
| Hydroxypropyl | TY11A | 3.00 |
| methylcellulose | | |
| Hydroxypropyl | Methocel ® F240 | 1.50 |
| methylcellulose | | |

Example 1 was repeated with the exception that the batch ingredients were kept the same except the ratio of the Alumina 1:Alumina 2 was changed to 50:50.

### Example 4

### Preparative Example of Exemplary High Porosity Aluminum Titanate Having a Coarse to Fine Alumina Source Ratio: Alumina 1:Alumina 2=25:75

Table 4 lists exemplary aluminum titanate (AT) batch ingredients having the alumina source in the batch at a total amount of 49.67 wt %.

TABLE 4
Exemplary Aluminum Titanate (AT) Batch Ingredients.

| Ingredient | Ingredient Description | Wt % in batch |
|---|---|---|
| Alumina | Alumina 1 (Almatis A10-325) | 12.42% |
| | Alumina 2 (Almatis A2 -325) | 37.25% |
| Silica | US Silica Microsil 4515-200 | 10.31 |
| SrCO₃ | Solvay Type DF | 8.10 |
| CaCO₃ | OMYA Hydrocarb OG | 1.39 |
| TiO₂ | Dupont Ti-pure R101 | 30.33 |
| La₂O₃ | MolyCorp 5205 | 0.20 |
| Pore Formers | | |
| Graphite | Asbury 4566 | 8.00 |
| Starch | Native wheat | 20.00 |
| Binders | | |
| Hydroxypropyl | TY11A | 3.00 |
| methylcellulose | | |
| Hydroxypropyl | Methocel ® F240 | 1.50 |
| methylcellulose | | |

Example 1 was repeated with the exception that the batch ingredients were kept the same except the ratio of the Alumina 1:Alumina 2 was changed to 25:75.

### Example 5

### Preparative Example of Exemplary High Porosity Aluminum Titanate Having a Coarse to Fine Alumina Source Ratio: Alumina 1:Alumina 2=0:100

Table 5 lists exemplary aluminum titanate (AT) batch ingredients having the alumina source in the batch at a total amount of 49.67 wt %. Example 1 was repeated with the exception that the batch ingredients were kept the same except the ratio of the Alumina 1:Alumina 2 was changed to 0:100.

TABLE 5
Exemplary Aluminum Titanate (AT) Batch Ingredients.

| Ingredient | Ingredient Description | Wt % in batch |
|---|---|---|
| Alumina | Alumina 1 (Almatis A10-325) | 0 |
| | Alumina 2 (Almatis A2 -325) | 49.67 |
| Silica | US Silica Microsil 4515-200 | 10.31 |
| SrCO₃ | Solvay Type DF | 8.10 |
| CaCO₃ | OMYA Hydrocarb OG | 1.39 |
| TiO₂ | Dupont Ti-pure R101 | 30.33 |
| La₂O₃ | MolyCorp 5205 | 0.20 |
| Pore Formers | | |
| Graphite | Asbury 4566 | 8.00 |
| Starch | Native wheat | 20.00 |
| Binders | | |
| Hydroxypropyl | TY11A | 3.00 |
| methylcellulose | | |
| Hydroxypropyl | Methocel ® F240 | 1.50 |
| methylcellulose | | |

The disclosed composition and method are based on the use of blended fine (“Alumina 2”) and a relatively coarser particle size alumina (“Alumina 1”) in preparing high porosity aluminum titanate. As a demonstration, a series compositions having different fine to coarse (f:c) (Alumina 2:Alumina 1) particle size alumina ratios were used in combination with two pore formers to tailor the pore size of the resulting ceramic product while targeting about 55% overall porosity.

Table 6 lists exemplary wt % ranges of aluminum titanate (AT) batch ingredients.

TABLE 6
Aluminum titanate (AT) batch Alumina ingredient wt % ranges.

| Ingredient | Ingredient Description | wt % ranges in batch |
|---|---|---|
| Alumina | Alumina 1 (Almatis A10-325) | 44 to 52 |
| | Alumina 2 (Almatis A2 -325) | 52 to 44 |

The particle size distribution (PSD) listed in the Table 7 and the graph in FIG. 1 shows the particle size distributions in microns of the fine alumina (Alumina 2) and the coarse alumina (Alumina 1). As can be seen, the fine alumina (diamonds) (Alumina 2) is a much finer (d50_{Alumina 2}=7.35 microns; d50_{Alumina 1}=11.28 microns) particle size alumina and is also a bit narrower (dbreadth_{Alumina 2}=1.74; dbreadth_{Alumina 1}=1.80) than the coarse particle size alumina (squares) (Alumina 1). The d90's of these aluminas are also quite different, with the coarse particle size alumina having a d90 of 25.31 microns, and the fine particle size alumina has a d90 of 16.46 microns. The Y-axis is a measure of the relative amounts present or “% Channel” detected by a suitable particle size analyzer instrument. The observed particle size distribution (PSD) properties can depend on the type and model of the analyzer instrument used.

TABLE 7
Coarse and Fine Alumina Particle Properties.

| Alumina | d10 | d50 | d90 |
|---|---|---|---|
| coarse alumina (Alumina 1) | 4.99 | 11.28 | 25.31 |
| fine alumina (Alumina 2) | 3.67 | 7.35 | 16.46 |

Table 8 lists a summary of representative coarse and fine alumina ratios in the alumina titanate batches Examples 1 through 5. The fine to coarse (Alumina 2:Alumina 1) particle size alumina ratio was incrementally varied over the range from 0:100 to 100:0. Batch compositions were prepared and evaluated targeting the selected property of about 55% porosity in the fired ceramic article, using a pore former selected from, for example, a native wheat starch (Midsol 50), a crosslinked pea starch, a crosslinked corn starch, or mixtures thereof. All of the working Example compositions used 20 wt % starch and 8 wt % graphite, and were selected to take advantage of the lowering of pore size by the amount of fine particle size alumina (Alumina 2) added. Accordingly, batches having alumina ratios high in fine particle size alumina (Alumina 2) were matched with the largest pore former package (e.g., XL pea starch and graphite) and those with higher coarse particle size alumina (Alumina 1) content were matched with the smallest pore former package (e.g., XL corn starch and graphite). The compositions are listed in Table 9 and the resulting porosity properties are graphed in FIG. 2.

In general, the Table 9 data indicates that over the entire fine to coarse (Alumina 2:Alumina 1) particle size alumina ratio range of 0 to 100%, the use of fine particle size alumina (Alumina 2) did not substantially affect total porosity. There was a distinct linear effect of pore size in all d₁₀, d₅₀, and d₉₀ results. The coefficient of thermal expansion (CTE) was generally higher as the amount of the fine particle size alumina (Alumina 2) was increased, and modulus of rupture (MOR) was higher as a function of the fine particle size alumina content. There were no significant observable changes in shrinkage (green-to-fired or mask-to-fired). These results indicate that the fine particle size alumina can be an effective material for pore size control and that the fine particle size alumina can also function to increase the mechanical strength in an relatively weak composition.

The disclosure has been described with reference to various specific embodiments and techniques. However, it should be understood that many variations and modifications are possible while remaining within the scope of the disclosure.

TABLE 8
Summary of Coarse and Fine Alumina Ratios
in Example Alumina Titanate Batches.

| Example | % Alumina 1 | % Alumina 2 |
|---|---|---|
| 1 | 100 | 0 |
| 2 | 75 | 25 |
| 3 | 50 | 50 |
| 4 | 25 | 75 |
| 5 | 0 | 100 |

100% Alumina 1 refers to 100% of the 49.67% total alumina or Almatis A10 -325.
100% Alumina 2 refers to 100% of the 49.67% total alumina or Almatis A2 -325.
Intermediate ratios such as 75:25, 50:50; and 25:75 refer to the respective blends of Alumina 1 and Alumina 2.

TABLE 9
Summary of Porosity, Particle Size, CTE, MOR, and Shrinkage Properties in
Example Alumina Titanate Batches.

| | | | | | | | | | Negative |
|---|---|---|---|---|---|---|---|---|---|
| | | | | | | | | | Shrinkage |
| | | | | | | CTE | CTE | | (mask to |
| Example | % porosity | d10 | d50 | d90 | Df | (800) | (1000) | MOR | fired) |
| 1 | 54.96 | 9.59 | 13.88 | 19.61 | 0.3091 | 5.9 | 9.5 | 150 | −3.18% |
| 2 | 55.14 | 8.90 | 13.45 | 18.83 | 0.3383 | 5.4 | 9.1 | 171 | −2.79% |
| 3 | 54.54 | 8.73 | 12.43 | 16.75 | 0.2977 | 4.8 | 8.1 | 196 | −3.39% |
| 4 | 54.63 | 7.53 | 11.27 | 15.20 | 0.3319 | 6.2 | 10.4 | 209 | −3.40% |
| 5 | 55.12 | 6.94 | 10.54 | 14.21 | 0.3416 | 7.5 | 11.3 | 223 | −3.37% |

What is claimed is:

1. A method of making an aluminum titanate ceramic article comprising:
selecting properties for the aluminum titanate-containing ceramic body to be made by the method, the selected properties include pore size, modulus of rupture (MOR), or a combination thereof;
selecting a fine-to-coarse weight ratio (f:c) of fine alumina particles and coarse alumina particles for a batch, the total amount of the fine and the coarse alumina particles is from 44 to 52 weight percent of the batch;
forming an aluminum titanate batch mixture including the selected fine-to-coarse weight ratio (f:c) of the fine alumina particles and the coarse alumina particles;
forming a green body from the batch mixture; and
firing the green body to obtain an aluminum titanate-containing ceramic body having the selected properties.

2. The method of claim 1 wherein the selected fine-to-coarse weight ratio (f:c) of the fine and the coarse alumina particles is fixed for a particular batch.

3. The method of claim 1 further comprising, in a subsequent method of making:
varying the fine-to-coarse weight ratio (f:c) of the fine alumina particles and the coarse alumina particles for the batch; and
holding the amount of all other batch ingredients constant, wherein the selected properties in the resulting fired green body are adjusted to a different value compared to the prior method of making.

4. The method of claim 1 wherein the fine-to-coarse weight ratio (f:c) of the fine and the coarse alumina particles is from 0:100 to 100:0.

5. The method of claim 1 wherein the total amount of all alumina particles is 47 to 50 weight percent of the batch.

6. The method of claim 1 wherein the fine alumina particles comprise a first alumina having a median particle size of 6 to 10 micrometers and the coarse alumina particles comprise a second alumina having a median particle size of 10 to 13 micrometers.

7. The method of claim 1 further comprising the batch including a pore former package comprising one or more pore formers in an amount from 5 to 30 weight percent based on superaddition to the inorganic components of the batch.

8. The method of claim 7 wherein the pore former package is selected from starch and graphite.

9. The method of claim 1 wherein firing the green body comprises heating in a gas fired kiln for 16 hr and cooling to ambient temperature.

10. The method of claim 1 wherein firing provides an aluminum titanate ceramic article having a pore size from 11 to 14 microns, and a modulus of rupture (MOR), from 150 to 223 MPa.

11. The method of claim 1 wherein the selected modulus of rupture (MOR) property is from 140 to 280 MPa.

12. The method of claim 1 wherein the selected pore size property is a d50 from 10 to 20 microns.
